(19) United States
(12) Patent Application Publication
(10) Pub. No.: US 2009/0016704 A1
(43) Pub. Date: Jan. 15, 2009

(54) INFORMATION REPRODUCTION DEVICE, INFORMATION REPRODUCTION METHOD, AND INFORMATION REPRODUCTION PROGRAM

(76) Inventors: Hiroyuki Takeuchi, Osaka (JP); Shinichi Kimura, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/091,886

(22) PCT Filed: Oct. 6, 2006
(86) PCT No.: PCT/JP2006/320100

§ 371 Date: Apr. 28, 2008

(30) Foreign Application Priority Data
Oct. 28, 2005 (JP) 2005-313782

(51) Int. Cl. H04N 5/85

(52) U.S. Cl. 386/126; 386/E05.064

(57) ABSTRACT

Even when the frame identifying pattern at the head is misjudged or cannot be obtained, the frame identifying pattern that follows on and the frame corresponding to that frame identifying pattern are acquired and are held, and the position of the frame is judged on the basis of the information of the frame identifying pattern at a timing when the acquired frame identifying pattern is switched, and the positions of all the frames which have been acquired until then are calculated uniquely. Therefore, even when the preamble identifying pattern cannot be correctly detected due to such as flaws, the positions of the frames in the blocks are correctly detected, and the data can be certainly demodulated.

### TECHNICAL FIELD

The present invention relates to an information reproduction device, an information reproduction method, and an information reproduction program which acquires information at the BCA (Burst Cutting Area) area from an optical disc more certainly.

### BACKGROUND ART

As a disk recording medium which has optically recorded digital data of such as a high definition digital video signal, for example, a DVD (Digital Versatile Disc or Digital Video Disc) oriented to exclusive use for reproduction is widely known. In addition, as a disc recording medium that has enabled additional writing and rewriting using this format, a DVD-R (DVD-Recordable) disc, a DVD-RW (DVD-ReWritable) disc, and a DVD-RAM (DVD-Random Access Memory) disc have been generally used.

Further, by employing a combination of blue laser light of 405 nm and an objective lens having a laser numerical aperture (NA) of 405 nm, a next generation disc called as Blu-Ray has been commercialized as having a large capacity of about 23 G bytes or more though it has a track pitch of 0.32 μm, a linear density of 0.12 μm/bit, and a diameter of 120 mm.

In these next generation optical discs, a recording layer is provided on a substrate, a transparent cover layer of about 0.1 mm thickness is further provided on the recording layer, and the laser light is irradiated to the recording layer through the transparent cover layer of 0.1 mm thickness. Herein, the transparent cover layer is provided to pursuit superior optical characteristics and further, a barcode is executed onto the cover layer so as to reduce the affection by such as flaws.

By the way, in the present DVD, laser light is irradiated from the side of the transparent substrate having 0.6 mm thickness. Therefore, it can be thought that even in the present DVD, if a transparent cover layer is made thin as in the above-described next generation optical disc, the spot diameter of the laser light on the recording layer can be made small.

However, when the spot diameter of laser light on the recording layer is made small, large influences are affected due to dusts or wastes of sizes, by which the laser light is not so much affected when it has a large spot diameter.

Accordingly, when the data is reproduced from the next generation optical disc which has a thin transparent cover layer, an identifier pattern or the like for detecting the head of the data can not be correctly detected with relative to the present DVD, there increasing cases where the data cannot be reproduced.

This problem may arise, of course, in the data area where the contents data of an optical disc are recorded, and may arise in the BCA (Burst Cutting Area) area where the disc ID is recorded as well.

Herein, as a conventional technique which enables a more certain reproduction of main data even when the head of a block cannot be correctly detected due to such as dusts or flaws, there is a technique which, in addition to providing an identifying pattern which identifies the head of a block that serves as a recording/reproduction unit, assigns a particular identifying pattern which is different from the identifying patterns which are included in other frames, to head frames of all the small blocks which constitute the particular block, and further, assigns identifying data for identifying each small block to each head frame of each small block, and thereby enables to detect the head of each block by detecting the predetermined identifying pattern which is assigned to each small block even when the identifying pattern for identifying the head of each block cannot be correctly detected, and thereby enabling to detect the head of each block (patent document 1).

Patent Document 1: Japanese Published Patent Application No. 11-73738

### DISCLOSURE OF THE INVENTION

### Problems to be Solved by the Invention

However, the above-described method cannot be used for the areas into which the recording is already performed such as the BCA area of Blu-Ray or BCA area of DVD, because it is not possible to newly write in a particular pattern prior to those already recorded area. Accordingly, in the area where the recording is already performed as the above-described BCA area, if it is not possible to detect an identifying pattern for detecting the head of a block which constitutes a recording/reproduction unit due to dusts or flaws, it is not possible to recognize the head of the block even by the above-described conventional method, and thereby it is not possible to reproduce that block.

Particularly, since no information is recorded prior to the head frame in the above-described BCA area as is different from the other user regions, it was not possible to detect the head frame of the BCA region from the information that is obtained from the frame located prior thereto.

The present invention is directed to solving the above-described problems and has its object to provide an information reproduction device, an information reproduction method, and an information reproduction program which can certainly reproduce the data by detecting the head frame correctly even when the identifying pattern which was assigned to the head of a block cannot be corrected due to flaws and dusts.

### MEASURES TO SOLVE THE PROBLEMS

In order to solve the above-described problems, according to the present invention, there is provided an information reproduction device where a frame comprises data of a predetermined data amount, a frame block comprises a plurality of the frames, a preamble frame is arranged in front the frame block, each of the frames has at its head position a frame identifying pattern for identifying each frame, which frame identifying pattern is changed for a predetermined number of frames, the preamble frame has at its head position a preamble identifying pattern which is different from the respective frame identifying patterns in the frame block, and the device reproduces the recorded data which are recorded with making a block comprising the frame block and the preamble frame as a unit, the device comprises: a frame information acquiring part which acquires and holds each of the frame identifying patterns and data of each frame in front of which the frame identifying pattern is arranged, a frame information detection part which detects whether the frame identifying pattern which was acquired by the frame information acquiring part is different from the frame identifying pattern which was acquired by one pattern prior, and a frame position calculation part which calculates the frame positions in the frame block, of the respective frames which have been acquired by the frame information acquiring part, on the basis of the information of the frame identifying pattern which is detected as different from the frame identifying pattern that is acquired by one pattern prior by the frame information detection part.

Thereby, even if the preamble identifying pattern cannot be acquired or is not acquired, it is possible to certainly reproduce the recording data that is recorded with making a block comprising the frame block and the preamble block as a unit.

Further, the unit recording data includes a final identifying pattern which is different from any of the respective identifying patterns and the preamble identifying pattern, which final identifying pattern is arranged at rear the frame block.

Further, the unit recording data includes a post-amble frame which is arranged at rear the frame block.

Further, the unit recording data comprises a post-amble frame which is arranged at rear the frame block and in front the final identifying pattern.

According to an information reproduction device of the present invention, the frame information detection part counts the number of times at which the same frame identifying pattern is acquired by the frame information acquiring part and detects whether the count value has reached a predetermined number or not, and the frame position detection part calculates the frame positions in the frame block, of the respective frames which have been acquired until then, on the basis of the frame identifying pattern which is included in the frame, for which the count value is detected as having reached the predetermined number of times in the frame information detection part.

Thereby, in the information reproduction device, it is possible to calculate at which frame position in the block which includes the particular frame each of the respective frames which are acquired until then is located, on the basis of that the same frame identifying patterns are obtained successively for a predetermined number of times and the information itself of the frame identifying pattern, even when the preamble identifying pattern cannot be obtained or is not obtained.

Further, according to an information reproduction device of the present invention, the frame information detection part detects whether the frame identifying pattern which was acquired by the frame information acquiring part is the final identifying pattern or the post-amble frame, and the frame position detection part calculates the frame positions in the frame block, of the respective frames which have been acquired until then by the frame information acquiring part, when the final identifying pattern or the post-amble frame is detected by the frame information detection part, on the basis of the information of the frame identifying pattern which is possessed by the frame which was acquired by one frame prior.

Thereby, in the information reproduction device, it is possible to calculate the frame positions in the frame block, of the respective frames which have been acquired until then, when the final identifying pattern or the post-amble frame in the block is detected, on the basis of that information, even when the preamble identifying pattern cannot be obtained or is not obtained.

Further, according to the present invention, there is provided an information reproduction device where a frame comprises data of a predetermined data amount, a frame block comprises a plurality of the frames, a preamble frame is arranged in front the frame block, an error correction block comprises the frames of a predetermined number in the frame block, each of the frames has at its head position a frame identifying pattern for identifying each frame, which frame identifying pattern is changed for a predetermined number of frames, the preamble frame has at its head position a preamble identifying pattern which is different from the respective frame identifying patterns in the frame block, and the device reproduces the recorded data which are recorded with making a block comprising the frame block and the preamble frame as a unit, and the device comprises: a frame information acquiring part which acquires and holds data of each frame which includes each frame identifying pattern, a frame information detection part which counts the number of the frame identifying patterns which were acquired by the frame information acquiring part and detects whether its count value has reached the predetermined number or not, an error correction situation detection part which carries out, after the acquirement of the frame identification patterns of a predetermined number is detected by the frame information detection part, an error correction using a predetermined number of frames including the acquired frame each time when a frame is acquired by the frame information acquiring part, thereby to detect the error correction situation, and a frame position calculating part which calculates the frame positions in the frame block, of the respective frames which have been obtained until then by the frame information acquiring part, on the basis of the information of the frame identifying patterns which are possessed by the predetermined number of frames, for which the optimum error correction result is detected by the error correction situation detection part.

Thereby, it is possible to certainly reproduce the recorded data which are recorded with making a block comprising the frame block including the error correction block and the preamble frame, even when the preamble identifying pattern cannot be obtained or is not obtained. In addition, according to the present invention, there is provided an information reproduction method where a frame comprises data of a predetermined data amount, a frame block comprises a plurality of the frames, a preamble frame is arranged in front the frame block, each of the frames has at its head position a frame identifying pattern for identifying each frame, which frame identifying pattern is changed for a predetermined number of frames, the preamble frame has at its head position a preamble identifying pattern which is different from the respective frame identifying patterns, and the method reproduces the recorded data which are recorded with making a block comprising the frame block and the preamble frame as a unit, the method comprises: a frame information acquiring step comprising acquiring and holding the frame identifying pattern and data of each frame in front which the frame identifying pattern is arranged, a frame information detection step comprising detecting whether the frame identifying pattern which was acquired by the frame information acquiring step is different from the frame identifying pattern which was acquired by one pattern prior, and a frame position calculation step comprising calculating the frame positions in the frame block, of the respective frames which have been acquired until then by the frame information acquiring step, on the basis of the information of the frame identifying pattern which is possessed by the frame that is acquired at last at the timing when the frame identifying pattern is detected as different in the frame information detection step.

Thereby, it is possible to, when reproducing data with making a block comprising the frame block and the preamble frame as a unit, certainly reproduce the recorded data, even when the preamble identifying pattern cannot be obtained or is not obtained.

Further, according to the information reproduction method of the present invention, the frame information detection step comprises counting the number of times at which the same frame identifying pattern is acquired by the frame information acquiring step, and detecting whether the count value has reached a predetermined number or not, and the frame position detection step comprises calculating the frame positions in the frame block, of the respective frames which have been acquired until then by the frame information acquiring step, on the basis of the frame identifying pattern which is arranged in the frame which was finally detected, at the timing when it is detected that the predetermined number of times is reached in the frame information detection step.

Thereby, even when the preamble identifying pattern cannot be acquired or is not acquired, when reproducing the recorded data with making a block comprising the frame block and the preamble frame as a unit, it is possible to calculate the frame positions in the frame block, of respective frames which have been acquired until then, on the basis of the information of the frame identifying pattern at the timing when the frame identifying patterns have been the same for the predetermined number successively.

Further, according to an information reproduction method of the present invention, the frame information detection step comprises detecting whether the frame identifying pattern which was acquired by the frame information acquiring step is the final identifying pattern or the post-amble frame, and the frame position detection step comprises calculating the frame positions in the frame block, of the respective frames which have been acquired until then by the frame information acquiring step, on the basis of the frame identifying pattern which is included in the frame that was acquired one frame prior at a timing when the final identifying pattern or the post-amble frame was detected in the frame information detection step.

Thereby, even when the preamble identifying pattern cannot be acquired or is not acquired, when reproducing recording data with making a block comprising the frame block and the preamble frame as a unit, it is possible to calculate the frame positions in the frame block, of respective frames which are acquired until then, at a timing when the final identifying pattern or the post-amble block in the block was detected.

According to the present invention, there is provided an information reproduction method where a frame comprises data of a predetermined data amount, a frame block comprises a plurality of the frames, a preamble frame is arranged in front the frame block, an error correction block is produced comprising the frames of a predetermined number included in the frame block, each of the frames has at its head position a frame identifying pattern for identifying each frame, which frame identifying pattern is changed for a predetermined number of frames, the preamble frame has at its head position a preamble identifying pattern which is different from the respective frame identifying patterns, and the method reproduces the recorded data which are recorded with making a block comprising the frame block and the preamble frame as a unit, the method comprises: a frame information acquiring step comprising acquiring the frame identifying pattern and data of the frame in front which the frame identifying pattern is arranged, a frame information detection step comprising counting the number of the frame identifying patterns which were acquired by the frame information acquiring step and detecting whether its count value has reached the predetermined number or not, an error correction situation detection step comprising carrying out, after the acquirement of the frame identification patterns of the predetermined number is detected by the frame information detection step, an error correction using the predetermined number of frames including the acquired frame each time when the frame is acquired by the frame information acquiring step and detecting the error correction situation, and a frame position calculating step comprising calculating the frame positions in the frame block, of the respective frames which have been acquired until then by the frame information acquiring step, on the basis of the information of the frame identifying patterns which are possessed by the predetermined number of frames for which the optimum error correction is carried out, at the timing when the optimum error correction result is detected in the error correction situation detection step.

Thereby, even when the preamble identifying pattern cannot be acquired or is not acquired when reproducing the recorded data with making a block comprising the frame block and the preamble frame as a unit, it is possible to certainly reproduce the recorded data.

According to the present invention, there is provided an information reproduction program where a frame comprises data of a predetermined data amount, a frame block comprises a plurality of the frames, a preamble frame is arranged in front the frame block, each of the frames has at its head position a frame identifying pattern for identifying each frame, which frame identifying pattern is changed each for a predetermined number of frames, the preamble frame has at its head position a preamble identifying pattern which is different from the respective frame identifying patterns, and the program making a computer execute an information reproduction processing that reproduces the recorded data with making a block comprising the frame block and the preamble frame as a unit, and making a computer execute: a frame information acquiring step comprising acquiring and holding data of each the frame including each the respective frame identifier pattern, a frame information detection step comprising detecting whether the frame identifying pattern which was acquired by the frame information acquiring step is different from the frame identifying pattern which was acquired by one pattern prior, and a frame position calculation step comprising calculating the frame positions in the frame block, of the respective frames which have been acquired until then by the frame information acquiring step, on the basis of the information of the frame identifying pattern which was included in the frame which was acquired at last, at a timing when a different frame identifying pattern is detected by the frame information detecting step.

Thereby, in the information reproduction device, even when the preamble identifying pattern cannot be acquired or is not acquired, when reproducing data with making a block comprising the frame block and the preamble frame as a unit, it is possible to certainly reproduce the recorded data.

According to an information reproduction program of the present invention, the frame information detection step comprises counting the number of times at which the same frame identifying pattern is acquired by the frame information acquiring step, and detecting whether the count value has reached a predetermined number or not, the frame position detection step comprises calculating the frame positions in the frame block, of the respective frames which have been acquired until then by the frame information acquiring step, on the basis of the frame identifying pattern which is included in the frame which was finally detected at the timing when it is detected that the predetermined time number is reached in the frame information detection step.

Thereby, in the information reproduction device, even when the preamble identifying pattern cannot be acquired or is not acquired, when reproducing the recorded data with making a block comprising the frame block and the preamble frame as a unit, it is possible to calculate the frame positions in the frame block, of respective frames which have been acquired until then, on the basis of the information of the frame identifying pattern at the timing when the frame identifying patterns have been the same for the predetermined number successively.

Further, according to the information reproduction program of the present invention, the frame information detection step comprises detecting whether the frame identifying pattern which was acquired by the information acquiring step is the final identifying pattern or the post-amble frame, and the frame position detection step comprises calculating the frame positions in the frame blocks, of the respective frames which have been acquired until then by the frame information acquiring step, on the basis of the information of the frame identifying pattern which is included in the frame which was acquired by one frame prior, at a timing when the final identifying pattern or the post-amble frame was detected in the frame information detection step.

Thereby, in the information reproduction device, even when the preamble identifying pattern cannot be acquired or is not acquired, when reproducing the recorded data with making a block comprising the frame block and the preamble frame as a unit, it is possible to calculate the frame positions in the frame block, of respective frames which have been acquired until then, at a timing when the final identifying pattern or the post-amble frame in the block is detected.

In addition, according to the present invention, there is provided an information reproduction program where a frame comprises data of a predetermined data amount, a frame block comprises a plurality of the frames, a preamble frame is arranged in front the frame block, an error correction block is produced comprising the frames of a predetermined number in the frame block, each of the frames has at its head position a frame identifying pattern for identifying each frame, which frame identifying pattern is changed each for a predetermined number of frames, the preamble frame has at its head position a preamble identifying pattern which is different from the respective frame identifying patterns, and the program making a computer execute an information reproduction processing that reproduces the recorded data with making a block comprising the frame block and the preamble frame as a unit, and making a computer execute: a frame information acquiring step comprising acquiring the identifying pattern and data of the frame in front which the frame identifying pattern is arranged, a frame information detection step comprising counting the number of the frame identifying patterns which were acquired by the frame information acquiring step and detecting whether its count value has reached the predetermined number or not, an error correction situation detection step comprising performing, after the acquirement of the frame identification patterns of the predetermined number is detected by the frame information detection step, an error correction using the predetermined number of frames including the acquired frame each time when the frame is acquired by the frame information acquiring step and thereby detecting the error correction situation, and a frame position calculating step comprising calculating the frame positions in the frame block, of the respective frames which have been acquired until then by the frame information acquiring step, on the basis of the information of the frame identifying pattern which is arranged in the predetermined number of frames for which the optimum error correction is carried out, at a timing when the optimum error correction result is detected in the error correction situation detection step.

Thereby, in the information reproduction device, even when the preamble identifying pattern cannot be acquired or is not acquired, when reproducing the recorded data with making a block comprising the frame block and the preamble frame as a unit, it is possible to certainly reproduce the recorded data.

### EFFECTS OF THE INVENTION

According to the information reproduction device, the information reproduction method, and information reproduction program of the present invention, in an information reproduction device where a frame comprises data of a predetermined data amount, a frame block comprises a plurality of the frames, a preamble frame is arranged in front the frame block, each the frame has at its head position a frame identifying pattern for identifying each frame, which frame identifying pattern is changed each for a predetermined number of frames, the preamble frame has at its head position a preamble identifying pattern which is different from the respective frame identifying patterns in the frame block, and the device reproduces the recorded data which are recorded with making a block comprising the frame block and the preamble frame as a unit, the device comprises: a frame information acquiring part which acquires and holds the respective frame identifier pattern and data of the frame in front which the frame identifying pattern is arranged, a frame information detection part which detects whether the frame identifying pattern which was acquired by the frame information acquiring part is different from the frame identifying pattern which was acquired by one pattern prior, and a frame position calculation part which calculates the frame positions in the frame block, of the respective frames which have been acquired by the frame information acquiring part, on the basis of the information of the frame identifying pattern which is detected as different from the frame identifying pattern that is acquired by one pattern prior by the frame information detection part. Therefore, when reproducing recorded data with making a block comprising a frame block and a preamble frame as a unit, it is possible to certainly reproduce the recorded data even if the preamble identifying data cannot be obtained or is not obtained.

Further, any of a final identifying pattern or a post-amble frame which is different from the identifying pattern or the preamble identifying pattern, or both are arranged at rear the frame block, the final identifying pattern or the post-amble frame is detected by the frame information detecting part, and on the basis of both detected results, which position frames in the above-described block all the frames which are acquired and held by the frame information acquiring part correspond to are calculated by the frame position calculating part. Therefore, even when the pre-amble identifying pattern in the recorded data cannot be detected or is not detected, it is possible to certainly reproduce the recorded data.

Further, according to the information reproduction device, the information reproduction method, and information reproduction program of the present invention, in an information reproduction device where a frame comprises data of a predetermined data amount, a frame block comprises a plurality of the frames, a preamble frame is arranged in front the frame block, an error correction block is produced comprising the frames of a predetermined number in the frame block, each of the frames has at its head position a frame identifying pattern for identifying each frame, which frame identifying pattern is changed for a predetermined number of frames, the preamble frame has at its head position a preamble identifying pattern which is different from the respective frame identifying patterns in the frame block, and the device reproduces the recorded data which are recorded with making a block comprising the frame block and the preamble frame as a unit, the device comprises: a frame information acquiring part which acquires each the identifying pattern and data of the frame in front which the frame identifying pattern is arranged and, a frame information detection part which counts the number of the frame identifying patterns which were acquired by the frame information acquiring part and detects whether its count value has reached the predetermined number or not, an error correction situation detection part which carries out, after the acquirement of the frame identification patterns of the predetermined number is detected by the frame information detection part, an error correction using the predetermined number of frames including the acquired frame each time when a frame is acquired by the frame information acquiring part and thus detects the error correction situation, and a frame position calculating part which calculates the frame positions in the frame block, of the respective frames which have been acquired until then by the frame information acquiring part, on the basis of the information of the frame identifying patterns which are possessed by the predetermined number of frames, for which the optimum error correction result is detected by the error correction situation detection part. Therefore, even when the preamble identifying pattern of the recorded data cannot be obtained or is not obtained, it is possible to certainly reproduce the recorded data.

### BRIEF DESCRIPTION OF THE DRAWINGS

FIG. 1 is a diagram illustrating a composition of an information reproduction device according to any of the first to third embodiments of the present invention.

FIG. 2 is a diagram illustrating a construction of the recorded data which is subjected to a reproduction processing in the information reproduction device according to the first to third embodiments of the present invention.

FIG. 3 is a flow chart illustrating a series of operations for obtaining the position of frame information without using the preamble identifying pattern in the information reproduction device of the first embodiment.

FIG. 4 is a flow chart illustrating a series of operations for obtaining the position of frame information without using the preamble identifying pattern in the information reproduction device of the second embodiment.

FIG. 5 is a flow chart illustrating a series of operations for obtaining the position of frame information without using the preamble identifying pattern in the information reproduction device of the third embodiment.

FIG. 6 is a diagram illustrating a diagram illustrating a construction of an information reproduction apparatus according to the fifth embodiment.

FIG. 7 is a diagram illustrating a construction of the recorded data which is subjected to a reproduction processing in the information reproduction device according to the fourth embodiment.

FIG. 8 is a flow chart illustrating a series of operations for obtaining the position of frame information without using the preamble identifying pattern in the information reproduction device of the fourth embodiment.

### DESCRIPTION OF REFERENCE NUMERALS

100, 300 . . . reproduction processing part

101, 301 . . . frame information acquiring part

102, 302 . . . frame information detecting part

103, 303 . . . frame position calculation part

104 . . . data holding part

110 . . . pick-up

111 . . . amplifier

112 . . . A/D conversion part

113 . . . modulation/demodulation part

200, 400 . . . frame

201, 401 . . . frame block

202, 402 . . . preamble frame

203, 403 . . . identifying pattern

204, 404 . . . preamble identifying pattern

205, 405 . . . final identifying pattern

304 . . . error correction situation detecting part

400d . . . data

400p . . . parity

406 . . . error correction block

1000, 2000 . . . information reproduction device

### BEST MODE TO EXECUTE THE INVENTION

### First Embodiment

Hereinafter, an information reproduction device according to a first embodiment of the present invention will be described with reference to the drawings.

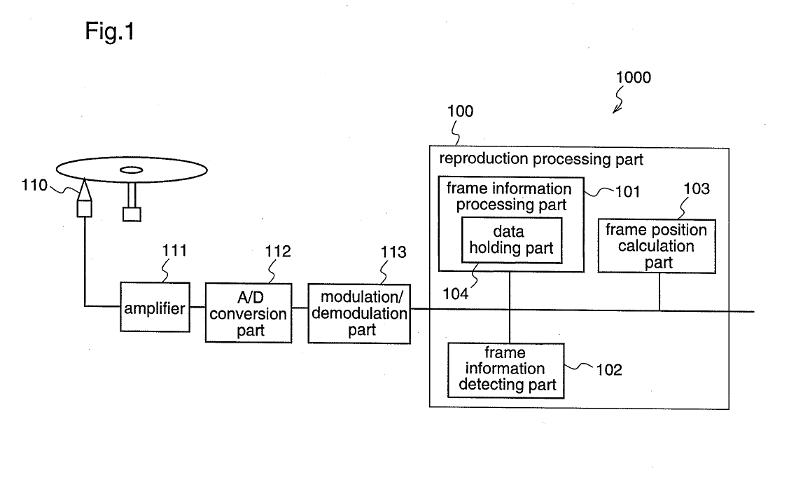

First, a construction of the information reproduction device 1000 according to the first embodiment will be described with reference to FIG. 1.

The information reproduction device 1000 according to the first embodiment is operated to read out, as shown in FIG. 1, the data at the BCA area of the optical disc by an optical pick-up 110, amplify the resulted signal by an amplifier 111, A/D converts the resulted signal by an A/D conversion part 112, and makes the data which was demodulated by a modulation/demodulation part 113 subjected to a reproduction processing by a reproduction processing part 100. The reproduction processing part 100 includes a frame information acquiring part 101 which has a data holding part 104, a frame information detecting part 102, and a frame position calculating part 103.

Herein, the data holding part 104 is not necessarily provided in the frame information acquiring part 101, and it may be provide separately, or if there may be a common recording area, it may be utilized. Or, if it is realized by such as a program, such as a memory may be employed.

Herein, the above-described frame information acquisition part 101 is operated to detect the frame identifying pattern which is included in each frame from the output of the modulation/demodulation part, and holds the detected result in the data holding part, and the frame information detecting part 102 is operated to detect whether the frame identifying pattern which was acquired by the frame information acquiring part 101 is different from the frame identifying pattern which was by one frame prior or not, and the frame position calculating part 103 is operated to calculate the frame positions in the frame blocks, of the respective frames which have been acquired by the frame information acquiring part 101, on the basis of the frame identifying pattern which was detected as different from the frame identifying pattern which was acquired by one frame prior by the frame information detecting part.

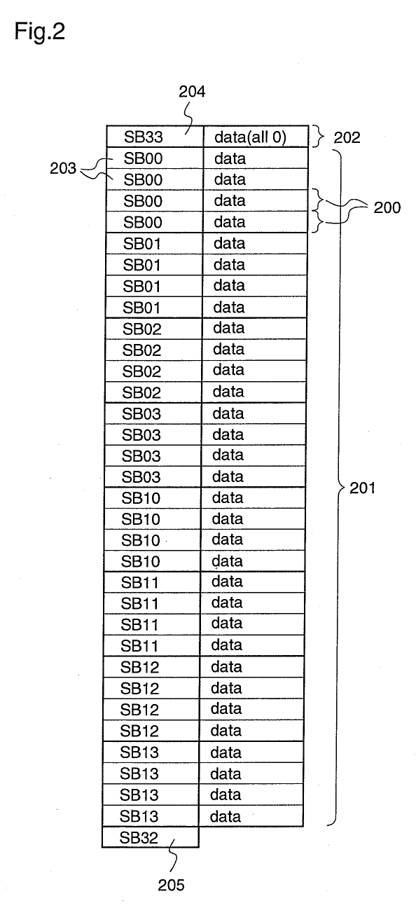

Next, a construction of data which is recorded in an optical disc and is subjected to a reproduction processing in the information reproduction device 1000 of the first embodiment will be described with reference to FIG. 2.

In FIG. 2, reference numeral 200 denotes a frame which comprises a predetermined amount of data, numeral 203 denotes an identifying pattern which is arranged at a head of the frame 200, and further, numeral 201 denotes a frame block which comprises frames 200 of a predetermined number, i.e., thirty two frames here.

Herein, the identifying pattern 203 in this first embodiment is not assigned to each frame 200 uniquely, but the same identifying pattern is assigned each for a predetermined number of, i.e., four frames 200.

In addition, numeral 202 denotes a preamble frame which is arranged in front the frame block 201, and a preamble identifying pattern 204 which is a particular identifying pattern that is different from the identifying patterns arranged at the top of the respective frames 200 is arranged at the head of the preamble frame 202.

Further, numeral 205 denotes a final identifying pattern which is a particular identifying pattern which is different from the identifying patterns 203 of the respective frames 200 and the preamble identifying pattern 204, which is arranged at rear the blocks 201. This final identifying pattern 205 may be not provided in this first embodiment.

An operation of the information reproduction device 1000 of this first embodiment will be described in detail hereinafter.

The information reproduction device 1000 having the above-described construction is operated to reproduce the recording data which makes each frame block 201 in front of which the preamble identifying pattern 204 is arranged as a unit as shown in FIG. 2, and the frame information acquiring part 101 acquires, even when the preamble identifying patter 204 is erroneously read out, or the preamble identifying pattern 204 cannot be acquired or is not acquired, the identifying pattern 203 which is included in each frame 200 of the frame block 201 and data of the frame 200.

Further, the frame information detection part 102 is operated to detect whether the identifying pattern 203 which is arranged at the head of each frame 200 is changed from the identifying pattern 203 that is acquired by one frame prior or not, and the frame position calculating part 103 is operated to, when the variation in the identifying pattern 203 is detected, calculate which position frames the respective frames which have been acquired and held by the frame information acquiring part 101 previously correspond to uniquely.

In more detail, the frame information acquiring part 101 is operated to read out data in an order of such as “SB00”, “data”, “SB00”, “data”, “SB01”, “data”, . . . , and hold these data in the data holding part 104 successively, and the frame information detection part 102 is operated to detect the change in the identifying pattern 203, i.e., the change from “SB00” to “SB01” in this case.

Then, the frame position calculating part 103 is operated to detect, from the information of the identifying pattern when the change in the identifying pattern 203 is detected by the frame information detection part 102, that the data to which the identifying pattern is added is (4n+1)-th (n≧1, n:integer) data, that is, when, for example, the identifying pattern which is acquired at a timing when the change is detected is “SB01”, the frame to which that identifying pattern is added is the fifth frame, and when it is “SB02”, the frame to which that identifying pattern is added is the ninth frame, is found, and thereafter, the frame positions of all the frames 200 which have been previously acquired by the frame information acquiring part 101 and held in the data holding part 104 are found by reverse operation.

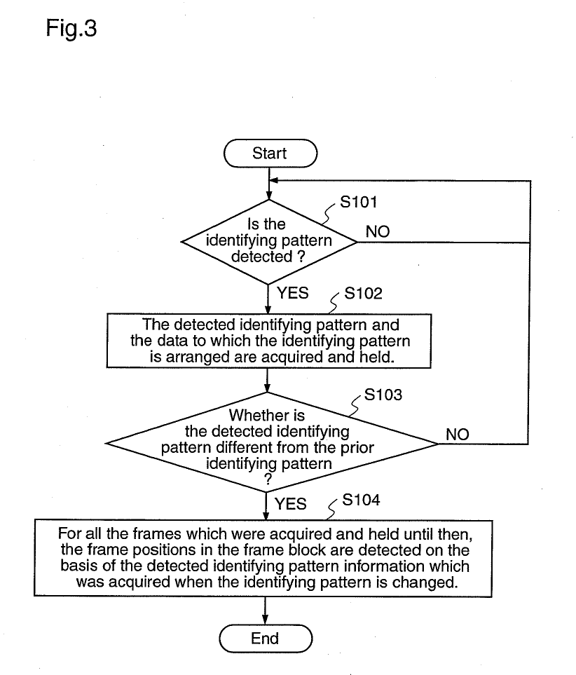

Hereinafter, a series of operations for finding the frame positions of respective frames without using the preamble identifying pattern 204 in the information reproduction device 1000 of the first embodiment will be described with reference to FIG. 3.

First of all, at starting reproduction of information, the frame information acquiring part 101 starts the detection of the identifying pattern 203 of respective frames 200 which are included in the frame block 201 (step S101).

If the identifying pattern 203 could be detected at step S101, the identifying pattern 203 and the data in the frame 200 to which the identifying pattern 203 is arranged at the head thereof are acquired by the frame information acquiring part 101 and are held in the data holding part 104 (step S102).

Further, in the frame information detection part 102, it is judged whether the identifying pattern 203 which was acquired by the frame information acquiring part 101 is different from the identifying pattern 203 which is acquired and held by one frame prior or not (step S103).

When in step S103 the identifying pattern 203 which was acquired this time and the identifying pattern 203 which was acquired at a previous time are the same, it again returns to step S101, and starts again the detection of the identifying pattern 203.

On the other hand, when in the step S103, the identifying pattern 203 which was acquired this time and the identifying pattern 203 which was acquired at a previous time are different and the change in the identifying pattern 203 is detected, it is found that how numbered frame the identifying pattern 203 which is acquired this time is, for example, it is fifth, ninth, or so on, is detected, and on the basis of that information, the frame positions in the frame block 201 for all the frames 200 which have been acquired by the frame information acquiring part 101 and held in the data holding part 104, are detected (step S104).

Besides, as for the frame positions of the respective frames 200 which are acquired by the frame information acquiring part 101, after finding the positions of all the frames which are held in the data holding part 104, since the frame positions of all the frames which are acquired until then are already found, it is possible to easily detect the frame positions of the respective frames 200.

In this way, according to the information reproduction device 1000 of this first embodiment, when reproducing the recording data which makes one comprising the preamble identifying pattern 204, the frame block 20, and the final identifying pattern 205 as a unit, even if the preamble pattern 204 which is arranged in front the block 201 cannot be acquired or is not obtained, the identifying pattern 203 in the block 201 that follows and the data to which the identifying pattern is added are acquired by the frame information acquiring part 101 and are held in the data holding part 104, and further, the timing when the identifying pattern 203 of the frame 200 is changed is detected by the frame information detection part 102, and on the basis of the information of the identifying pattern 203 at the timing when the identifying pattern 203 is changed, which position frame among in the block 201 each of all the frames 200 which have been acquired by the frame information acquiring part 101 and held in the data holding part 104 corresponds to is found by the frame position detection part 103. Therefore, it is possible to certainly reproduce the data in the frame block 201, and as a result, it is possible to enhance the ability of reproducing the recorded data.

### Second Embodiment

Hereinafter, an information reproduction apparatus according to a second embodiment of the present invention will be described.

First, a construction of the information reproduction device of this second embodiment will be described.

The information reproduction device of this second embodiment includes, in addition to being provided with the frame information acquiring part 101 that is provided with the data holding part 104, the frame information detection part 102, and the frame position calculating part 103 similarly as the information reproduction apparatus 1000 of the first embodiment, an identifying patter counter 102a (not shown) which counts the number of the identifying patterns 203 which have been acquired by the frame information acquiring part 101 that is provided in the frame information detection part 102.

The construction of the data which is reproduced by the information reproduction device of this second embodiment is the same as that shown in FIG. 2 in the first embodiment.

While in the first embodiment the change in the identifying patter 203 is detected in the frame information detection part 102, and on the basis of the information of the identifying pattern at the timing when the identifying pattern 203 is changed, the frame positions of all the frames 200 which have been previously acquired by the frame information acquiring part 101 and held are found in the frame position calculating part 103, in this second embodiment, the change in the identifying pastern 203 is detected in the frame information detecting part 102, and at the timing when the counting of the number of times when the identifying pattern 203 is successively the same has reached a predetermined number, the frame positions of all the frames 200 which have been acquired and are held in the data holding part 104 are calculated uniquely on the basis of the information of the acquired identifying pattern 203 by the frame position calculating part 103.

For example, when the frame information acquiring part 101 is operated to read out the respective frames 200 which are included in the block 201 as “SB00”, “data”, “SB00”, “data”, “SB00”, “data”, “SB00”, “data”, “SB01”, . . . , to hold those data successively, the identifying pattern 203 is detected, and further, the number of the same identifying patterns 203 is counted by the identifying pattern counter 102a that is provided in the frame information detection part 102, and also whether the number has reached a predetermined number, for example, 4 or not is detected. Then, the frame position calculating part 103 is operated to find, on the basis of the information of the identifying pattern 203 when the count value of the identifying pattern counter 203a has reached a predetermined number, i.e., “4” here, the positions of the frames which are acquired previously by the frame information acquiring part 101 and are held in the data holding part 104 by reverse calculation, since it is found that the frame 200 is a 4n-th one (n is an integer of n≧1), i.e., that the frame 200 is a fourth one when the identifying pattern which is acquired when the count value of the identifying counter has become “4” is “SB00”, while that the frame 200 is an eighth one when it is “SB01”.

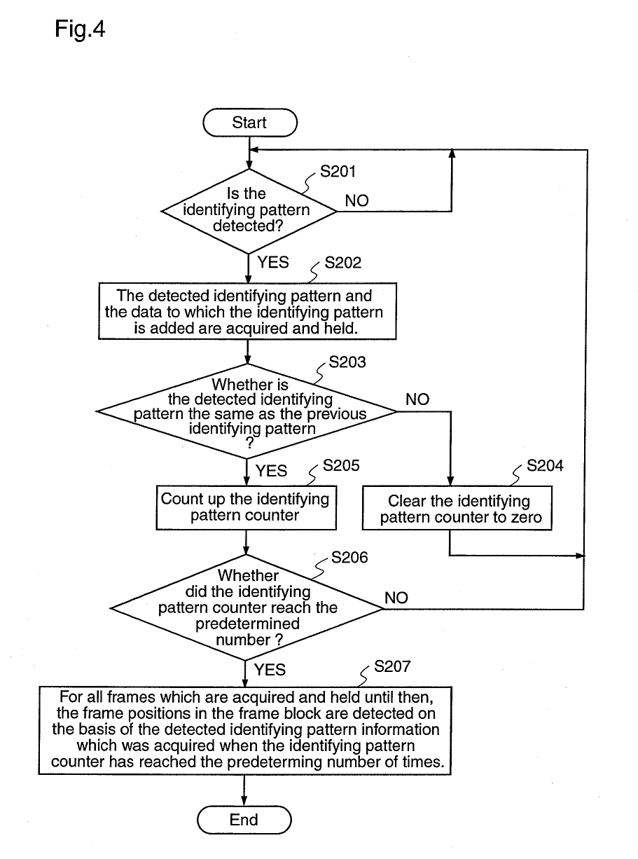

Hereinafter, a series of operations for finding the frame positions of respective frames without using the preamble identifying pattern 204 in the information reproduction device 2000 of the second embodiment will be described with reference a flow diagram of to FIG. 4.

First of all, at starting reproduction of information, the frame information acquiring part 101 starts the detection of the identifying pattern 203 (step S201).

If the identifying pattern 203 can be detected at step S201, the identifying pattern 203 and the data to which the identifying pattern 203 is added are acquired by the frame information acquiring part 101 and are held in the data holding part 104 (step S202).

Further, in the frame information detection part 102, it is detected as to whether the identifying patter 203 which was acquired by the frame information acquiring part 101 is the same as the identifying pattern 203 which is acquired and held at a previous time or not (step S203).

Then, if the identifying pattern that was previously acquired is different from the identifying pattern which is acquired this time, the identifying pattern counter 102a in the frame information detection part 102 is cleared to zero (step S204), it again returns to step S201, and starts again the detection of the identifying pattern 203 by the frame information acquiring part 101.

On the other hand, if the identifying pattern is the same in the step S203, the identifying pattern counter 102a in the frame identifying detection part 102 is operated to count up (step S205), and confirm whether the count value of the identifying pattern counter has reached the predetermined number of times, i.e., 4 times or not (step S206).

Then, when the count value of the identifying pattern counter 102a is not the predetermined number of times, that is, not 4, it again returns to step S201, and starts again the detection of the identifying pattern 203 by the frame information acquiring part 101.

On the other hand, when in step S206, the count value of the identifying pattern counter 102a has reached the predetermined time number, i.e., 4, on the basis of the information of the identifying pattern that is obtained at that timing, all the frames 200 which are acquired by the frame information acquiring part 101 and are held in the data holding part 104 until then, are found on which position frames in the frame block 201 they correspond to, respectively (step S207).

Besides, as for the frame positions of the respective frames 200 which are acquired by the frame information acquiring part 101, after finding the positions of all the frames which are held in the data holding part 104, since the frame positions of all the frames which are acquired until then are already found, it is possible to easily detect the frame positions of the respective frames 200.

In this way, according to the information reproduction device 2000 of this second embodiment, even when the preamble identifying pattern 204 which is arranged in front the frame block 201 cannot be acquired, the identifying pattern 203 in the block and the data to which the identifying pattern was added are acquired by the frame information acquiring part 101 and are held in the data holding part 104, and further, whether the identifying pattern 203 of each frame 200 is the same as the previous one is detected and whether the number of times at which being the same is detected has reached a predetermined number is detected in the frame information detecting part 102, and on the basis of the information of the identifying pattern 203 at the timing when the number of times at which being the same has reached the predetermined number, it is found, for all the frames 200 which are acquired and held until then, on which position frames in the frame block 201 they correspond to, respectively, in the frame position detection part 103. Therefore, even if the preamble identifying pattern 204 cannot be acquired, it is possible to certainly reproduce the recorded data, and as a result, it is possible to enhance the ability of reproducing data.

### Third Embodiment

Hereinafter, an information reproduction device of a third embodiment of the present invention will be described.

First, a construction of the information reproduction device according to the third embodiment will be described.

The information reproduction device according to this third embodiment includes, similarly as the information reproduction device 1000 of the first embodiment, the frame information acquiring part 101 that is provided with the data holding part 104, the frame information detection part 102, and the frame position calculating part 103, and further, a construction of the data which is reproduced by this information reproduction device is one that has arranged the final identifying pattern 205 at last of the data, similarly as that shown in FIG. 2 as is described in the first embodiment.

More particularly, in the above-described first embodiment, it is operated to detect the change in the identifying patter 203 in the frame information detection part 102, and to find the frame positions of all the frames 200 which were previously acquired by the frame information acquiring part 101 and are held from the information of the identifying patter at the timing when the identifying pattern 203 is changed. In the third embodiment, however, it is operated to detect the final identifying pattern 205 by the frame information identifying detecting part 102, and to detect the frame positions of all the frames 200 which are acquired by the frame information acquiring part 101 and are held in the data holding part 104 on the basis of the identifying pattern 203 which was acquired by one pattern prior to the final identifying pattern 205 uniquely by the frame information acquiring part 101.

For example, the frame information acquiring part 101 is operated to read out the respective frames 200 which are included in the block 201 as . . . “SB13”, “data”, “SB13”, “data”, “SB32” to hold those data successively, and the frame information detection part 102 judges whether the acquired identifying pattern 203 is the final identifying pattern 205 or not. Then, the frame position calculating part 103 calculates, when the acquired identifying pattern 203 which was judged as the final identifying pattern by the frame information detection part 102, the frame positions of all the frames 200 which have been acquired by the frame information acquiring part 101 and held in the data holding part 104 previously by reverse operation, since it is found that the frame 200 that is acquired by one frame prior is the final frame, i.e., the 32-th frame in the block 201.

In this way, this third embodiment utilizes that it is found that when the final identifying pattern 205 is detected by the frame information detection part 102, the data which is by one prior to that is the final data in the frame block 201.

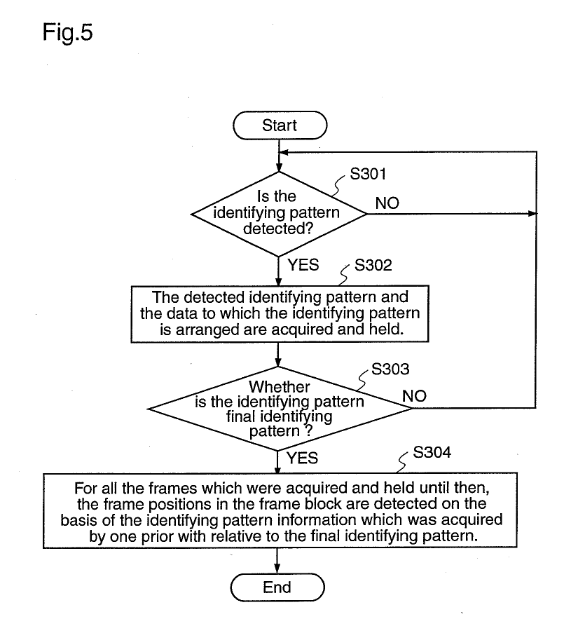

Hereinafter, a series of operations for finding the frame positions of respective frames 200 without using the preamble identifying pattern 204 in the information reproduction device 3000 of the third embodiment will be described with reference to FIG. 5.

First of all, at starting reproduction of information, the frame information acquiring part 101 starts the detection of the identifying pattern 203 of respective frames 200 which are included in the block 201 (step S301).

If the identifying pattern 203 can be detected at step S301, the identifying pattern 203 and the data in the frame 200 to which the identifying pattern 203 is arranged at the head thereof are acquired by the frame information acquiring part 101 and are held in the data holding part 104 (step S302).

Further, in the frame information detection part 102, it is judged whether the identifying pattern 203 which was acquired by the frame information acquiring part 101 and was held in the data holding part 104 is the final identifying pattern 205 or not (step S303).

When in step S303 it is judged as the acquired identifying pattern being not the final identifying pattern 205, it again returns to step S301, and starts again the decision of the identifying pattern in the frame information acquiring part 101. On the other hand, when the acquired identifying pattern is judged as the final identifying pattern 205 in step S303, since it can be found that the frame that is acquired by one prior is the final frame in the frame block 201, the frame position calculating part 103 finds on which position data in the frame block 201 the respective frames 200 which have been acquired by the frame information acquiring part 101 and are held in the data holding part 104 correspond to, respectively(step S304).

Besides, in this third embodiment, it is possible to find the frame positions of all the frames 200 which are included in the block at the timing when the above-described series of operations are concluded.

In this way, according to the information reproduction device 3000 of the third embodiment, even when the preamble identifying pattern cannot be acquired in the frame information acquiring part 101, it is detected as to whether the acquired identifying pattern 203 is the final identifying pattern 205 or not by the frame information detecting part 102, and on the basis of that the frame 200 which was acquired by one prior with relative to the detected final identifying pattern 205 is the final frame that is included in the block 201, all the frames 200 which have been obtained previously are found on which position frames in the frame block 201 they correspond to respectively. Therefore, even when the preamble identifying pattern 204 cannot be acquired, it is possible to certainly reproduce the recorded data, and as a result, it is possible to enhance the ability of reproducing he recorded data.

While in the third embodiment, a construction in which the final identifying pattern 205 is provided at rear the block 201 is raised as a construction of the recorded data which are subjected to reproduction processing in this information reproduction device, it is not limited thereto.

For example, it may such that not a final identifying pattern 205 but a post-amble frame may be arranged after the frame block 201, or it may such that a post-amble frame is arranged at rear the frame block 201 and further a final identifying pattern may be arranged at rear that.

Then, when the recorded data is constituted as such, it may be judged in the frame information detection part 102, not on whether the identifying patter is the final identifying pattern or not, but on whether it is a post-amble frame or not.

### Fourth Embodiment

Hereinafter, the information reproduction device of the fourth embodiment will be described.

In the information reproduction device 2000 of this fourth embodiment, an error correction block is produced comprising frames of a predetermined number in the frame block, an error correction is carried out for each the error correction block, and on the basis of the information of the identifying patterns of the frames which are included in the error correction block, for which the optimum error detection result is obtained, the frame positions in the frame block of the respective frames which have been acquired and held are calculated.

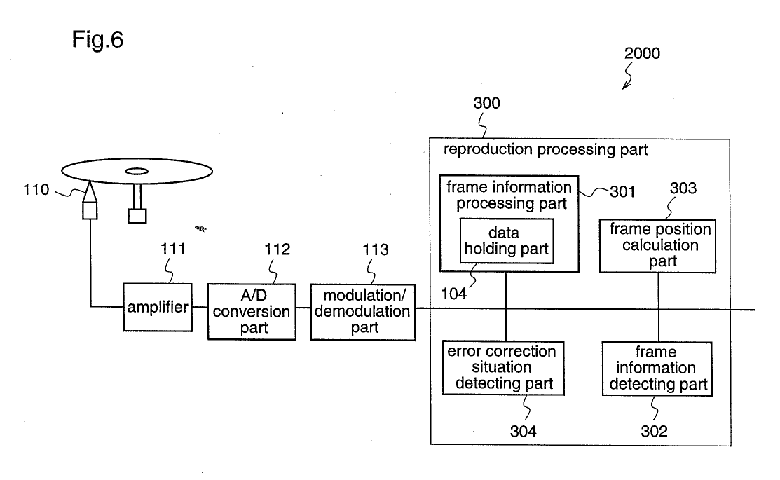

The construction of the information reproduction device 2000 of this fourth embodiment will be described with reference to FIG. 6.

The information reproduction device 2000 of the fourth embodiment is operated to read out, as shown in FIG. 6, the data in the BCA area of the optical disc by an optical pick-up 110, amplify the resulted signal by the amplifier 111, digitally convert the resulted signal by the A/D converter 112, demodulate the resulted signal by the modulator/demodulator 113, and making the resulted signal subjected a reproduction processing by the reproduction processing part 300, and the reproduction processing part 300 includes the frame information acquiring part 301 having the data holding part 104, the frame information detection part 302 that is provided with an identifying pattern counter 302a (not shown), the frame position calculating part 303, and an error correction circumstances detection part 304 which carries out error correction and detects the error correction circumstance.

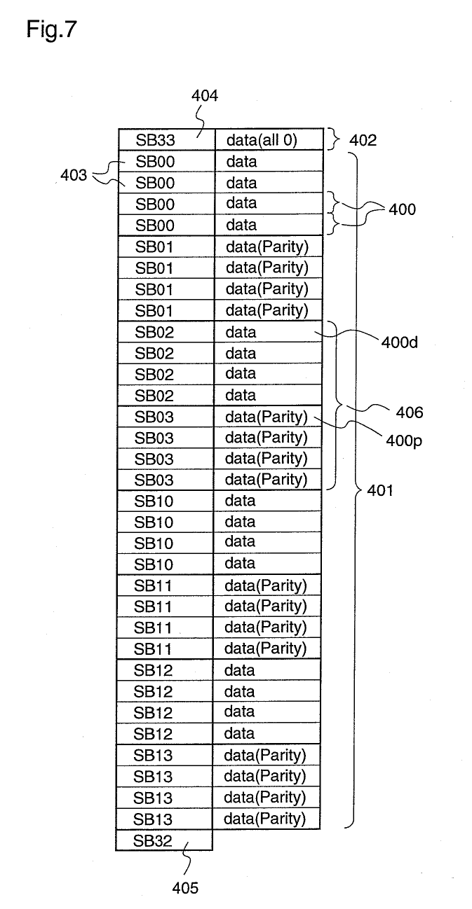

Herein, the construction of the data which is recorded in the optical disc and subjected to the reproduction processing in the information reproduction device 2000 of this fourth embodiment will be described with reference to FIG. 7.

In FIG. 7, numeral 400 denotes a frame which is produced comprising a predetermined data amount, numeral 403 denotes an identifying pattern which is arranged at the head of the frame 400, and numeral 401 denotes a frame block which is produced comprising frames of a predetermined number, i.e., thirty two frames 400 here.

In addition, in this fourth embodiment the identifying pattern 403 is not one that is assigned to each frame 400 uniquely, but the same identifying pattern is assigned for a predetermined number of frames, i.e., four frames here.

Further, in the fourth embodiment, an error correction block 406 which is a unit by which an error correction is performed is produced, and the error correction block 406 is constituted comprising the data (400d) of four frames 400 and four parities (400p) for those.

Further, numeral 402 denotes a preamble frame which is arranged in front the frame block 401, and at the head of the preamble frame 402, a preamble pattern 404 as a particular pattern, which is different from the identifying patterns 403 which are arranged at the head of the respective frames 400, is arranged.

In addition, numeral 405 denotes a final identifying pattern as a particular pattern, which is arranged at rear the frame block 401, and is different from the identifying pattern 403 of the respective frames 400 and also from the preamble identifying pattern 404.

Hereinafter, an operation of the information reproduction device 2000 of the fourth embodiment will be described in detail.

The above-mentioned information reproduction device 2000 having the construction as described above is operated to reproduce the recorded data which is recorded with making a block comprising the frame block 401 in front which the above-described preamble identifying pattern 404 is arranged and the preamble frame 402 as a unit, and the frame information acquiring part 301 is operated to, even when the preamble identifying pattern 404 is erroneously read out, or the preamble identifying pattern 404 can not be acquired or is not acquired, acquire the identifying patterns 403 included in the respective frames 400 of the frame block 401 and the data in the frames 400, make those be held in the data holding part 104.

The above-described frame information detection part 302 is operated to count up the number of the identifying patterns 403 which are acquired by the frame information acquiring part 301 by the identifying pattern counter 302a, and judges whether the count value has become above a predetermined number, i.e., 8 here, or not, and the error correction situation detection part 304 is operated to carry out an error correction, after the count value has become above the predetermined number, using a predetermined number of frames, i.e., 8 frames here, which comprise the frame which was acquired and the frames which have been held until then, each time when each frame 401 is acquired by the frame information acquiring part 301, and thereby to detect the error correction block 406 by which an appropriate error correction result is obtained, and the frame position calculating part 303 is operated to calculate on which frame positions in the frame block 401 the respective frames 400 which have been previously acquired by the frame information acquiring part 301 and are held correspond to uniquely on the basis of the information of the identifying patterns 403 of the frames 400 which are included in the error correction block 406 which is detected by the error correction situation detection part 304.

More particularly, the frame information acquiring part 301 is operated to read out, for example, as “SB00”, “data”, “SB00”, “data”, “SB01”, “data”, . . . , to hold those data in the data holding part successively, and the frame information detection part 302 counts up the number of the identifying patterns 403 which are acquired by the frame information acquiring part 301 using the identification pattern counter 302a.

Then, when the count value has become above the predetermine value, i.e., “8” here, each time when the frame 400 is acquired by the frame information acquiring part 301, the error correction situation detection part 304 carries out an error correction processing to the error correction block 406 which comprises the frame 400 that is acquired this time and seven frames 400 which have been acquired and held, and thereby detects the error correction situation on whether the error correction result is most appropriate one or not.

Here, as this error correction, an appropriate error correction processing is carried out only when the eight frames 400 included in the error correction block 406 has become a combination of four successive data 400d and four successive parities 400p, and thus, the error correction situation detection part 304 detects the error correction block 406 which comprises a combination of four successive data 400d and four successive parities 400p, and thereby detects an appropriate error correction situation.

Then, the frame position calculating part 303 recognizes that the eight data to which their identifying patterns are added are 8n+1-th data to 8(n+1)-th data (n≧0, n: integer) from the information of the identifying patterns 403, which are included in the respective frames 400 of the eight frames by which the optimum error correction result is obtained, and finds the frame positions in the frame block 400, of the respective frames, and thereafter, finds the positions of all the frames which have been previously acquired by the frame information acquiring part 301 and are held in the data holding part 104 by reverse operation.

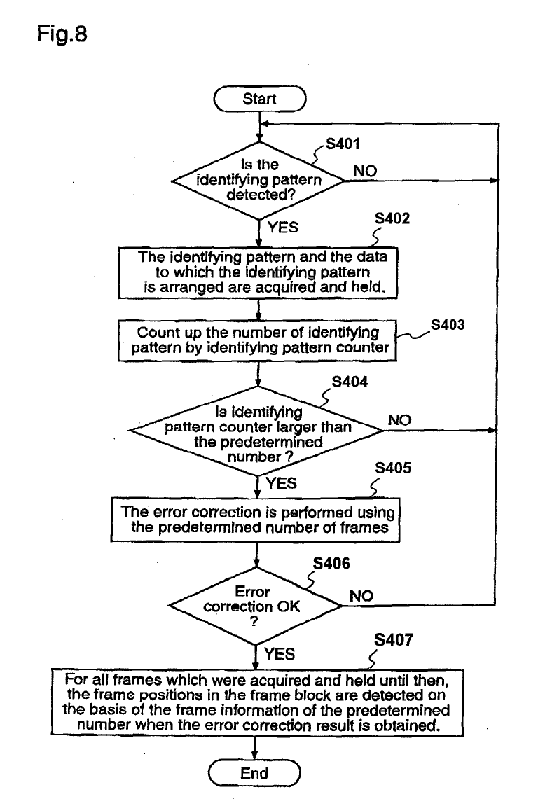

Hereinafter, a series of operations for finding the frame positions of the respective frames 400 without using the preamble identifying pattern in the information reproduction device 2000 of the fourth embodiment will be described with reference a flow diagram of to FIG. 8.

First of all, at starting reproduction of information, the detection of the identifying pattern 403 of the respective frames 400 which are included in the frame block 400 is started by the frame information acquiring part 301 (step S401). If the identifying pattern 403 could be detected at step S401, the identifying pattern 403 and the data to which the identifying pattern 403 is added are acquired by the frame information acquiring part 301 and are held in the data holding part 104 (step S402).

Further, in the identifying pattern counter 302a in the frame information detection part 302, the number of the identifying patterns 403 which are acquired by the frame information acquiring part 301 is counted (step S403), and it is confirmed that the count value has reached the predetermined time number, i.e., “8”here or not(step S404).

When in step S404, the predetermined number, i.e., “8” is not yet reached, it again returns to step S401, and the frame information acquiring part 301 again starts the detection of the identifying pattern 403.

On the other hand, when it is detected that the predetermined number, i.e., “8”, is reached in step S404, an error correction is carried out using the data which was included in the predetermined number (“8”) of frames which have been acquired until then by the error correction situation detection part 304 (step S405), and whether an optimum error correction result can be obtained or not, i.e., the error correction situation is detected (step S406).

Then, when it is judged as being not the optimum error correction result, it again returns to step S401, and again starts the detection of the identifying pattern 403. On the other hand, when it is judged as the optimum error correction result having been obtained, on the basis of the information of the identifying patterns 403 of a predetermined number, i.e., “8”, the frame positions in the frame block 401, of the eight frames 400 by which the optimum error correction result are obtained are found, and on the basis of that information, the frame positions in the frame block 401, of all the frames 400 which are acquired by the frame information acquiring part 401 and are held in the data holding part 104 are found (step S407).

Besides, as for the frame positions of the respective frames 400 which are acquired by the frame information acquiring part 301, after having found the positions of all the frames which are held in the data holding part 104, since the frame positions of all the frames 400 which are acquired until then are already detected, it is possible to easily find the frame positions of the respective frames 400.

As described above, according to the information reproduction device 4000 of the fourth embodiment, when reproducing the recorded data which makes one comprising the frame block 401 and the preamble frame 402 and further including parities 400p as shown in FIG. 7, even if the preamble identifying pattern 404 which is arranged in front the frame block 401 cannot be acquired or is not acquired in the frame information acquiring part 301, and it is detected in the frame position detection part 303 on which position frames in the block 401 the respective frames which are acquired by the frame information acquiring part 401 and are held by the data holding part 104 correspond to, respectively, on the basis of the information of the identifying patterns 403 which are included in the error correction block 406 at a timing when the error correction result is judged as optimum in the error correction information detection part 304. Therefore, it is possible to certainly reproduce the recorded data even when the preamble identifying pattern 404 can not be acquired, and it is possible to enhance the ability of reproducing the data.

### APPLICABILITY IN INDUSTRY

According to the information reproduction device of the present invention, even if the identifying pattern for detecting the head is not detected, the subsequent frame information can be reproduced, and it is effective for such as reproduction of BCA area of DVD or Blu-Ray. Further, in a case where the information that follows is detected on the basis of the detection of the head, if the construction of data is the same as in the present invention, the present invention can be applied thereto.

1-6. (canceled)

7. An information reproduction device wherein:
a frame comprises data of a predetermined data amount,
a frame block comprises a plurality of said frames,
a preamble frame is arranged in front said frame block,
an error correction block comprises said frames of a predetermined number in said frame block,
each of said frames has at its head position a frame identifying pattern for identifying each frame, which frame identifying pattern is changed for a predetermined number of frames,
said preamble frame has at its head position a preamble identifying pattern which is different from the respective frame identifying patterns in said frame block, and
said device reproducing the recording data which are recorded with making a block comprising said frame block and said preamble frame as a unit, said device comprising:
a frame information acquiring part which acquires and holds data of each frame including said each identifying pattern,
a frame information detection part which counts the number of said frame identifying patterns which were acquired by said frame information acquiring part and detects whether its count value has reached said predetermined number or not,
an error correction situation detection part which carries out, after the acquirement of the frame identification patterns of a predetermined number is detected by said frame information detection part, an error correction using a predetermined number of frames including the acquired frame each time when a frame is acquired by said frame information acquiring part, and further detects the error correction situation, and
a frame position calculating part which calculates the frame positions in said frame block, of said respective frames which have been obtained until then by said frame information acquiring part, on the basis of the information of said frame identifying patterns which are possessed by the predetermined number of frames, for which the optimum error correction result is detected by the error correction situation detection part.

8-13. (canceled)

14. An information reproduction method where:
a frame comprises data of a predetermined data amount,
a frame block comprises a plurality of said frames,
a preamble frame is arranged in front said frame block,
an error correction block is produced comprising said frames of a predetermined number included in said frame block,
each of said frames has at its head position a frame identifying pattern for identifying each frame, which frame identifying pattern is changed for a predetermined number of frames,
said preamble frame has at its head position a preamble identifying pattern which is different from the respective frame identifying patterns, and
said method reproduces the recording data which are recorded with making a block comprising said frame block and said preamble frame as a unit, the method comprising:
a frame information acquiring step comprising acquiring said frame identifying pattern and data of the frame in front which said frame identifying pattern is arranged,
a frame information detection step comprising counting the number of said frame identifying patterns which were acquired by said frame information acquiring step and detecting whether its count value has reached said predetermined number or not,
an error correction situation detection step comprising carrying out, after the acquirement of said frame identification patterns of said predetermined number is detected by said frame information detection step, an error correction using the predetermined number of frames including the acquired frame each time when said frame is acquired by said frame information acquiring step and detecting the error correction situation, and
a frame position calculating step comprising calculating the frame positions in said frame block, of said respective frames which have been acquired until then by said frame information acquiring step, on the basis of the information of said frame identifying patterns which are possessed by the predetermined number of frames for which the optimum error correction is carried out, at the timing when the optimum error correction result is detected in the error correction situation detection step.

15-20. (canceled)

21. An information reproduction program where
a frame comprises data of a predetermined data amount,
a frame block comprises a plurality of said frames,
a preamble frame is arranged in front said frame block,
an error correction block is produced comprising said frames of a predetermined number in said frame block,
each of said respective frames has at its head position a frame identifying pattern for identifying each frame, which frame identifying pattern is changed each for a predetermined number of frames,
said preamble frame has at its head position a preamble identifying pattern which is different from the respective frame identifying patterns, and
said program making a computer execute an information reproduction processing that reproduces the recording data with making a block comprising said frame block and said preamble frame as a unit, and making a computer execute,
a frame information acquiring step comprising acquiring said frame identifying pattern and data of said frame in front which said frame identifying pattern is arranged,
a frame information detection step comprising counting the number of said frame identifying patterns which were acquired by said frame information acquiring step and detecting whether its count value has reached said predetermined number or not,
an error correction situation detection step comprising performing, after the acquirement of said frame identification patterns of said predetermined number is detected by said frame information detection step, an error correction using the predetermined number of frames including the acquired frame each time when said frame is acquired by said frame information acquiring step and thereby detecting the error correction situation, and
a frame position calculating step comprising calculating the frame positions in said frame block, of said respective frames which have been acquired until then by said frame information acquiring step, on the basis of the information of said frame identifying pattern which are included in the predetermined number of frames for which the optimum error correction is carried out, at a timing when the optimum error correction result is detected in the error correction situation detection step.
